(19) United States
(12) Patent Application Publication
(10) Pub. No.: US 2020/0265752 A1
(43) Pub. Date: Aug. 20, 2020

(54) TOUCH CONTROL ASSEMBLY FOR THE BLIND AND TOUCH CONTROL DEVICE FOR THE BLIND

(71) Applicant: PAX COMPUTER TECHNOLOGY (SHENZHEN) CO.,LTD., Shenzhen, Guangdong (CN)

(72) Inventors: Xiaojin Sun, Shenzhen, Guangdong (CN); Wunchun Chau, Shenzhen, Guangdong (CN); Sheng Chen, Shenzhen, Guangdong (CN); Xiaojun Huang, Shenzhen, Guangdong (CN)

(21) Appl. No.: 15/767,154

(22) PCT Filed: Mar. 12, 2018
(86) PCT No.: PCT/CN2018/078707

§ 371 Date: Apr. 10, 2018

(30) Foreign Application Priority Data
Dec. 28, 2017 (CN) 201721886849.9

(51) Int. Cl. G09B 21/00; G06F 3/02; B65D 65/22; G06F 3/0488

(52) U.S. Cl. CPC G09B 21/004; G06F 3/0488; B65D 65/22; G06F 3/021

(57) ABSTRACT

A touch control assembly for the blind includes a screen protection film provided on a touch screen and configured for protecting the touch screen, and a plurality of key frames are provided at the screen protection film and are tactually sensible via fingers, wherein at least one of the key frames is provided with a braille part tactually sensible via fingers. A touch control device for the blind includes the touch control assembly for the blind. The touch control assembly for the blind, through the design of the screen protection film, the key frame, and the braille part arranged on the screen protection film, which enables the touch control assembly for the blind usable by the blind people.

### FIELD OF THE INVENTION

The present application relates to the technical field of touch control, and more particularly to a touch control assembly for the blind and a touch control device for the blind.

### DESCRIPTION OF THE RELATED ART

With the development of science and technology, the application of electronic devices is becoming increasingly widespread. Mobile phone online payment and communication with family and friends through mobile phone or tablet personal computer, are becoming essential in daily life of people. However, for blind people, due to the fact that their eyes cannot see, electronic devices can not be applied at all, particularly, such as the POS devices, the mobile phones and the tablet personal computers, which are with a touch screen. Because the surface of the touch screen is flat and smooth, the blind people cannot sense it with fingers. Therefore the blind people cannot operate it at all. As a result, the blind people can be separated from reality in a lot of situations, and feel inferior and helpless.

### SUMMARY OF THE INVENTION

An object of the present application is to provide a touch control assembly for the blind, in order to solve the technical problems existing in the prior art that the touch screen surface of a device with a touch screen is smooth, the blind people cannot sense or operate the device with their fingers.

In order to achieve the above objects, the technical solutions of the present application provides a touch control assembly for the blind, comprising a circuit board, a display screen electrically connected with the circuit board, and a touch screen electrically connected with the circuit board and provided on the display screen, wherein a screen protection film is provided on the touch screen and is configured for protecting the touch screen, and a plurality of key frames are provided at the screen protection film and are tactually sensible via fingers, wherein at least one of the key frames is provided with a braille part tactually sensible via fingers.

Preferably, the screen protection film is a toughened film or a plastic film.

Preferably, the length of the screen protection film is larger than or equal to the length of the display screen, and the width of the screen protection film is larger than or equal to the width of the touch screen.

Further, the positions of the key frames correspond to the positions of the respective key zones as displayed on the display screen, and the position of the braille part corresponds to the position of the respective numeric symbol zone as displayed on the display screen.

Further, the touch control assembly for the blind further includes an audio module, the audio module is electrically connected with the circuit board and is configured for sending out a voice prompt.

Preferably, crossed grooves are provided in screen protection film, wherein the key frames are block zones enclosed by the grooves, and the braille part is convexly arranged in the block zone.

Preferably, the key frame is convexly arranged at the screen protection film, and the braille part is convexly arranged in the key frame.

Preferably, the key frame is a recess concavely arranged at the screen protection film, and the braille part is convexly arranged inside the recess.

Another object of the present application is to provide a touch control device for the blind, comprising a back casing, a middle frame connected with the back casing, wherein the touch control device for the blind further includes said touch control assembly for the blind, the circuit board is provided in between the back casing and the middle frame, wherein the display screen, the touch screen and the screen protection film are sequentially arranged on the middle frame.

Further, the touch control device for the blind further includes a payment module electrically connected with the circuit board, a keypad electrically connected with the circuit board, a USB socket electrically connected with the circuit board, and a TF card socket electrically connected with the circuit board.

The beneficial effects of the touch control assembly for the blind as provided by the present application are as follows: compared with the prior art, the touch control assembly as provided by the present application through the arrangement of the screen protection film, wherein the key frame which can be sensed and touched by fingers is provided on the screen protection film, and the braille part which can be sensed and touched by fingers is arranged at the key frame. Therefore, when the touch control assembly is used by the blind people, the position of the key frame on the screen protection film can be sensed by fingers, and then the position of the braille part at the key frame can be sensed, so that correct numbers can be found and was entered through touch input. Thus, the touch control assembly for the blind can be operated by the blind people. In addition, the touch control device for the blind as provided by the present application, wherein the design of the touch control assembly for the blind enables the touch control device for the blind can be used by the blind people.

### BRIEF DESCRIPTION OF THE DRAWINGS

In order to illustrate the technical solutions provided by the embodiments of the present application more clearly, drawings required to be used in the description of the embodiments or in the prior art will be introduced briefly hereinafter. Obviously, the drawings in the following description are only for some embodiments of the present application. For those ordinary skilled in the art, other drawings can be obtained according to the drawings provided herein without creative efforts.

FIG. 1 is a three-dimensional schematic view of a touch control device for the blind as provided according to the embodiment 1 of the present application;

FIG. 2 is a schematic exploded view of the touch control device for the blind shown in FIG. 1;

FIG. 3 is a schematic top view of the touch control device for the blind shown in FIG. 1;

FIG. 4 is a sectional schematic view of the A_A section shown in FIG. 3;

FIG. 5 is a structural schematic view of the screen protection film, the key frame and the braille part shown in FIG. 1.

Wherein, reference numerals shown in the drawings:

1—Screen Protection Film; 2—Touch Screen; 3—Display Screen; 4—Key frame; 5—Braille Part; 6—Middle Frame; 7—Back Casing; 8—Keypad; 9—Circuit Board; 10—USB Socket; 11—Grooves; 31—Key zone; 32—Numeric symbol zone.

### DETAILED DESCRIPTION OF THE ENABLING EMBODIMENTS

In order to enable technical problems, technical solutions, and beneficial effects of the present application to be clearer and more understandable, the present application will be further described in detail hereinafter with reference to the drawings and embodiments. It should be understood that the specific embodiments described hereinafter are only intended to illustrate but not to limit the present application.

It should be noted that when an element is referred to as being “fixed” or “provided/arranged” to another element, it can be provided directly or indirectly to the other element. When an element is referred to as being “connected” to another element, it can be connected directly to the other element or indirectly to the other element.

It should be understood that the term “length”, “width”, “upper”, “lower”, “front”, “back”, “left”, “right”, “vertical”, “horizontal”, “top”, “bottom”, “inner” or “outer” and the like, the orientation or the position relationship indicated by said items is based on the orientation or position relationship shown in the drawings, which is only intended to facilitate the description of the present application and to simplify the description and is not to indicate or imply that the indicated device or element must possess a specific orientation, or must be constructed and operated in a specific orientation. Therefore, said items are not to be understood to be the limitation to the present application.

In addition, the terms “first” and “second” are used only for purposes of description, and are not understood to indicate or imply the relative importance or to implicitly indicate the number of the indicated technical features. Thus, the features limited by “first”, “second” can expressly or implicitly includes one or more of said features. In the description of the present application, “multiple” means that the number is two or more than two, unless being explicitly defined otherwise, and “plurality” means that the number is one or more than one, unless being explicitly defined otherwise.

### Embodiment 1

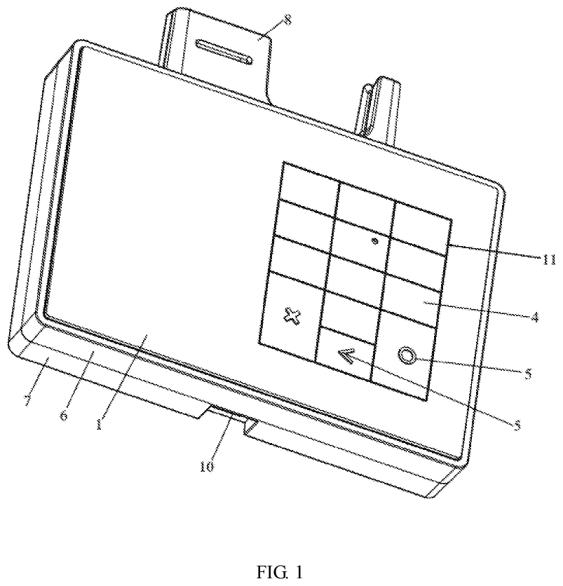

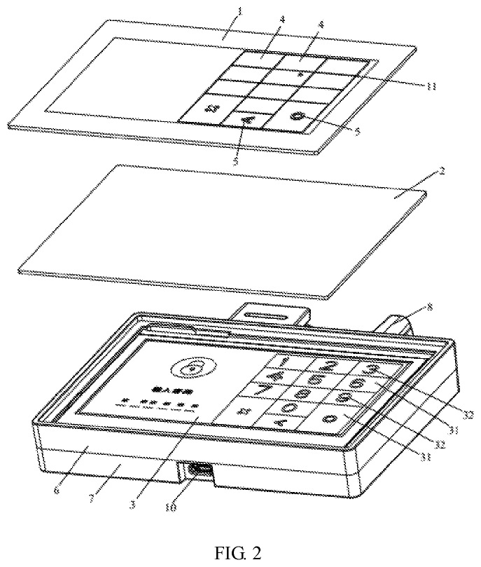

Referring to FIG. 1 to FIG. 5, a touch control assembly for the blind provided by the present application will be described hereinafter. The touch control assembly for the blind comprises a circuit board 9, a display screen 3, a touch screen 2 and a screen protection film 1. Wherein, the display screen 3 is electrically connected with the circuit board 9 and is configured for displaying images and videos; the touch screen 2 is electrically connected with the circuit board 9 and is attached to the display screen 3, and the touch screen 2 is configured for entering control instructions by fingers. The screen protection film 1 is attached to the touch screen 2 and is configured for protecting the touch screen 2. Referring to FIG. 2, the screen protection film 1 is provided with key frames 4 tactually sensible via ten fingers, wherein braille parts 5 tactually sensible via fingers are arranged on four of the key frames 4. The four said braille parts 5 are respectively a X part, a <part, a O part which are arranged at the lowest area, and a dot part arranged in the numeric symbol “5” region. Therefore, the blind people can distinguish the positions of other numbers through the four said braille parts 5. In an embodiment of the present application, the touch screen 2 and the screen protection film 1 are both in a sheet shape and transparent. In other word, the contents displayed on the display screen 3 can be seen clearly through the screen protection film 1 and the touch screen 2. In addition, in the embodiment, 10 key frames 4 are provided on the screen protection film 1, wherein four said key frames 4 are respectively provided with a braille part 5. Of course, in other embodiments of the present application, according to actual conditions and specific requirements, the screen protection film 1 can also be provided with nine, twelve or fifteen key frames 4. Meanwhile, the braille parts 5 are provided at two, three or five of the key frames 4. Furthermore, the position of the braille part 5, which is not limited herein, can be adjusted according to requirements.

Compared with the prior art, the touch control assembly for the blind provided by the present application, through the arrangements of the screen protection film 1; the key frames 4 arranged at the screen protection film 1 which can be touched and sensed by fingers, and the braille parts 5 arranged at the key frames 4 which can be touched and sensed; as shown in the embodiment, a X part, a <part, a O part arranged at the lowest area, and a dot part arranged in the numeric symbol “5” region, the blind people can distinguish the positions of other numbers and implement the touch input through sensing the positions of the key frames 4 at the screen protection film 1, and then sensing the positions of the X part, the <part, the O part and the dot part at the key frames by fingers. Therefore, the touch control assembly for the blind can be operated by the blind people.

Preferably, according to an embodiment of the touch control assembly for the blind provided by the present application, the screen protection film 1 is preferably a tempered pasting film and the thickness of the screen protective film is only 0.1 mm, so that the original screen surface can be covered completely, and the damage and scratches caused by external force can be prevented. Moreover, the impact absorbency is improved which is five times higher than the standard of the PET(Polyester) film, and the visual effect of the screen is not affected. According to the embodiment, a tempered pasting film is selected as a screen protection film 1, which enhances the use intensity and the service life of the touch control assembly for the blind. Thus, it is more suitable for the blind people to use.

Preferably, in other embodiments of the present application, according to actual conditions and specific requirements, a plastic pasting film also can be selected as the screen protection film 1. Particularly, the plastic pasting film is made of transparent PET materials, and the PET material is hard in texture with excellent endurance against scratching. Moreover, the manufacturing process is simple thereof, and compared with the tempered pasting film, the cost is significantly reduced.

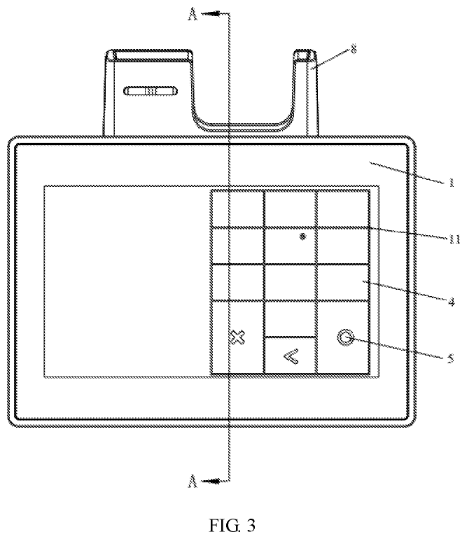

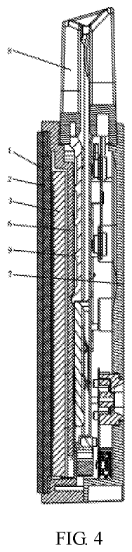

Preferably, referring to FIG. 4, according to an embodiment of the touch control assembly for the blind provided by the present application, the length of the screen protection film 1 is equal to the length of the touch screen 2, and the width of the screen protection film 1 is equal to the width of the touch screen 2. Moreover, the length of the screen protection film 1 is larger than the length of the display screen 3, the width of the screen protection film 1 is larger than the width of the display screen 3. In the embodiment, the length which is mentioned above is referred to the length in the left-right direction in FIG. 3, and the width which is mentioned above is referred to the width in the vertical direction in FIG. 3. Thus, the screen protection film 1 can completely protect the touch screen 2 and the display screen 3, and the numeric symbols displayed on the display screen 3 can be touched through the screen protection film 1. Of course, in other embodiments of the present application, according to actual conditions and specific requirements, the length of the screen protection film 1 can also be equal to the length of the display screen 3, the width of the screen protection film 1 can also be equal to the width of the display screen 3, but not limited thereto.

Further, according to an embodiment of the touch control assembly for the blind provided by the present application, referring to FIG. 2, it shows an embodiment of a screen display interface of the display screen 3. The position of the key frame 4 corresponds to the position of the key zone 31 displayed on the display screen 3, and the position of the braille part 5 corresponds to the position of the numeric symbol zone 32 displayed on the display screen 3, so that the display screen 3, the touch screen 2 and the screen protection film 1 are related to each other. The interface needing to be operated is displayed on the display screen 3, then the control instructions are entered through the screen protection film 1, and finally the touch control is implemented through the touch screen 2.

Further, according to an embodiment of the touch control assembly for the blind provided by the present application, the touch control assembly for the blind further includes a audio module. The audio module is electrically connected with the circuit board 9, and the audio module is configured for sending out a voice prompt to provide the blind people with the next operational instructions when the device is in use. Meanwhile, the numeric symbol is reported by the voice when the blind people are entering the numeric symbol so as to prevent the blind people from entering wrong numbers. Through the arrangement of the audio module, the function of the touch control assembly for the blind is more complete, and the touch control assembly for the blind is more suitable for the blind people to use.

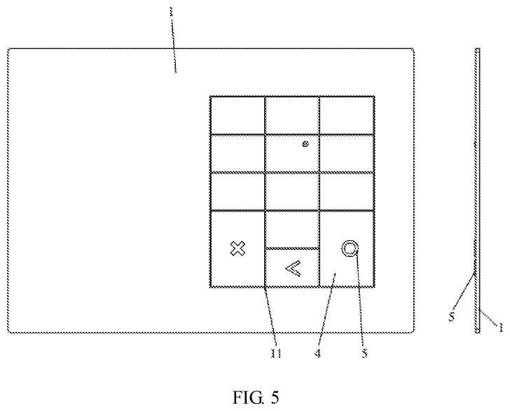

Preferably, referring to FIG. 1 and FIG. 5, according to an embodiment of the touch control assembly for the blind provided by the present application, crossed grooves 11 are provided in the screen protection film 1. The key frames 4 are block zones enclosed by the grooves 11, and the braille parts 5 is convexly arranged at the block zone. In the embodiment, the screen protection film 1 and the braille parts 5 can be integrally processed and then according to the size of the key frame 4, the grooves 11 with touch feelings are carved in the screen protection film 1 through a laser engraving process, so that the purpose of distinctions by the blind people is achieved.

The present application further provides a touch control device for the blind, referring to FIG. 1, FIG. 2 and FIG. 4, wherein the touch control device for the blind comprises a back casing 7, a middle frame 6 and said touch control assembly for the blind. The back casing 7 is connected with the middle frame 6 and both of them together forms a mounting cavity. The circuit board 9 is provided in between the back casing 7 and the middle frame 6 and is arranged in the mounting cavity. Wherein the display screen 3, the touch screen 2 and the screen protection film 1 are sequentially arranged on the middle frame 6. In the embodiment, the touch control device for the blind is a POS (Point of Sale) device for the blind people, and the touch control device for the blind further includes a payment module electrically connected with the circuit board 9, so that the blind people can carry out the cashier work through the POS device for the blind people. Of course, in other embodiments of the present application, the touch control device for the blind can also be a mobile phone for the blind people or a tablet personal computer for the blind people and the like as long as the device has a touch screen 2, but not limited thereto.

Further, referring to FIG. 1 and FIG. 2, as a specific embodiment of the touch control device for the blind provided by the present application, the touch control device for the blind further includes a payment module electrically connected with the circuit board 9, a keypad 8 electrically connected with the circuit board 9, a USB (Universal Serial Bus) socket 10 electrically connected with the circuit board 9, and a TF card (Trans-Flash card) socket electrically connected with the circuit board 9. Wherein, the payment module is configured for payment transaction; and the keypad 8 is configured for powering on the touch control device for the blind or for adjusting the volume; and the USB socket 10 is configured for charging the touch control device for the blind; and the TF card socket is configured for the entry of various software data into the touch control device for the blind.

### Embodiment 2

The touch control assembly for the blind in the embodiment 2 is basically the same as the touch control assembly for the blind in the embodiment 1, wherein the differences thereof are as follows: the key frame 4 is convexly arranged at the screen protection film 1, and the braille part 5 is convexly arranged at the key frame 4. According to the embodiment, the key frame 4 is convexly arranged at the screen protection film 1 so as to be distinguished by the blind people. Meanwhile, the braille part 5 is convexly arranged at the key frame 4 so as to be distinguished by the blind people. In other word, the screen protection film 1, the key frame 4 and the braille part 5 are in steps shape, which can be easily sensed by fingers and is suitable for the blind people to use. In the embodiment provided by the present application, the screen protection film 1, the key frame 4 and the braille part 5 are integrally molded through a mold, and the processing technology is simple and low in cost.

### Embodiment 3

The touch control assembly for the blind in the embodiment 3 is basically the same as the touch control assembly for the blind in the embodiment 1, wherein the differences thereof are as follows: the key frame 4 is a recess arranged at the screen protection film 1, and the braille part 5 is convexly arranged at the recess. According to the embodiment, the key frame 4 is distinguished through the recess, and meanwhile, the braille part 5 is convexly arranged at the recess so as to be distinguished by the blind people. Duo to the size of the key frame 4 is larger than that of the braille part 5, the size of the recess is larger than that of the braille part 5, so that the recess is easy to be recognized and is suitable for the blind people to use. In the embodiment, the top surface of the braille part 5 and the top surface of the screen protection film 1 are with equal height. In this case, the processing technology is to remove contents from the key frame 4 area except the braille part 5 at the screen protection film 1, the processing technology thereof is simple and low in cost.

### Embodiment 4

The touch control assembly for the blind in the embodiment 4 is basically the same as the touch control assembly for the blind in the embodiment 1, wherein the differences thereof are as follows: the key frame 4 is a rough zone polished at the screen protection film 1, and the braille part 5 is convexly arranged at the rough zone. In the embodiment, the screen protection film 1 and the braille part 5 can be integrally molded, and then according to the size of the key frame 4, the rough zone with touch feelings is polished at the screen protection film 1 through a sanding process, so that the purpose of distinctions by the blind people is achieved.

The above descriptions are only preferred embodiments of the present application, and are not intended to limit the present application. Any modification, equivalent replacement, improvement and the like, which are made within the spirit and principle of the present application, are all included in the protection scope of the present application.

1. A touch control assembly for the blind, comprising a circuit board, a display screen electrically connected with the circuit board, and a touch screen electrically connected with the circuit board and provided on the display screen, wherein a screen protection film is provided on the touch screen and is configured for protecting the touch screen, and a plurality of key frames are provided at the screen protection film and are tactually sensible via fingers, wherein at least one of the key frames is provided with a braille part tactually sensible via fingers.

2. The touch control assembly for the blind as claimed in claim 1, wherein the screen protection film is a toughened film or a plastic film.

3. The touch control assembly for the blind as claimed in claim 1, wherein the length of the screen protection film is larger than or equal to the length of the display screen, and the width of the screen protection film is larger than or equal to the width of the touch screen.

4. The touch control assembly for the blind as claimed in claim 3, wherein the positions of the key frames correspond to the positions of the respective key zones as displayed on the display screen, and the position of the braille part corresponds to the position of the respective numeric symbol zone as displayed on the display screen.

5. The touch control assembly for the blind as claimed in claim 4, wherein the touch control assembly for the blind further includes an audio module, the audio module is electrically connected with the circuit board and is configured for sending out a voice prompt.

6. The touch control assembly for the blind as claimed in claim 5, wherein crossed grooves are provided in screen protection film, wherein the key frames are block zones enclosed by the grooves, and the braille part is convexly arranged in the block zone.

7. The touch control assembly for the blind as claimed in claim 5, wherein the key frame is convexly arranged at the screen protection film, and the braille part is convexly arranged in the key frame.

8. The touch control assembly for the blind as claimed in claim 5, wherein the key frame is a recess concavely arranged at the screen protection film, and the braille part is convexly arranged inside the recess.

9. A touch control device for the blind, comprising a back casing, a middle frame connected with the back casing, wherein the touch control device for the blind further includes the touch control assembly for the blind as claimed in claim 1, the circuit board is provided in between the back casing and the middle frame, wherein the display screen, the touch screen and the screen protection film are sequentially arranged on the middle frame.

10. The touch control device for the blind as claimed in claim 9, wherein the touch control device for the blind further includes a payment module electrically connected with the circuit board, a keypad electrically connected with the circuit board, a USB socket electrically connected with the circuit board, and a TF card socket electrically connected with the circuit board.
